(19) United States
(12) Patent Application Publication
(10) Pub. No.: US 2007/0109582 A1
(43) Pub. Date: May 17, 2007

(54) Image data storage device, photocopier, image forming system, and image data storage method

(75) Inventor: Yoshio Mizuyama, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/595,238

(22) Filed: Nov. 9, 2006

(30) Foreign Application Priority Data
Nov. 14, 2005 (JP) 2005-328954

(51) Int. Cl. G06F 3/12

(52) U.S. Cl. 358/1.13; 358/528

(57) ABSTRACT

A image data storage device includes an image data input unit, an image data recording unit, a compression processing unit, a region decision unit, and a compression control unit. The image data input unit receives input of image data. The image data recording unit records image data inputted by the image input unit. The compression processing unit compresses image data to be recorded in the image data recording unit. The region decision unit decides whether or not image data which has been inputted by the image input unit is image data related to an edge portion region of an image. And the compression control unit controls the compression processing unit so that compression processing is canceled for image data which has been decided, by the region decision unit, to be image data related to an edge portion region of an image.

### CROSS REFERENCE

This Nonprovisional application claims priority under 35 U.S.C. §119(a) on Patent Application No. 2005-328954 filed in Japan on Nov. 14, 2005, the entire contents of which are hereby incorporated by reference.

### BACKGROUND OF THE INVENTION

The present invention relates to an image data storage device, a photocopier, an image forming system, and an image data storage method in which inputted image data is stored, and in particular relates to an image data storage device, a photocopier, an image forming system, and an image data storage method which compress and store inputted image data.

An image data storage device is provided in the interior of an image forming device which prints image data upon paper, or of a display device which displays image data. Such an image data storage device has an image data recording unit for recording image data. Recently, in such an image data recording unit, it is often the case that the image data is recorded in a compressed state. The reason for this is that, by compressing the image data, the storage capacity which is needed for storing the image data becomes smaller.

However, if the image data is recorded in the compressed state, sometimes a delay has been created in processing when performing rotation processing of this image data. The reason for this is that, in order to rotate image data which is recorded, it is necessary to decompress all of the compressed image data, and the start of rotation processing is delayed by just the time spent waiting for the decompression processing to be completed.

As a countermeasure against this type of processing delay, in Japanese Laid-Open Patent Publication H08-224916 and Japanese Laid-Open Patent Publication H08-317225, there is disclosed a technique for separating image data which is to be compressed into a plurality of square blocks of image data, and compressing, decompressing, and rotating each of these square blocks of image data individually. It is possible to start the rotation processing even without waiting for the decompression processing to be completed, since, according to this technique, it is possible to start rotation processing of the image data at the time point that at least a single square block of image data has been decompressed.

However, with the technique described in Japanese Laid-Open Patent Publication H08-224916 and Japanese Laid-Open Patent Publication H08-317225, since, before reading out the first square block of image data, it is necessary to decompress the compressed image data before reading it out, accordingly the start of reading out the image data is still delayed, just as used previously to be the case. It is very important to prevent such delay in starting the reading out of the image data, since any delay in starting the reading out of the image data is experienced in sequence with delay in output processing for the image data.

The object of the present invention is to provide an image data storage device, a photocopier, an image forming system, and an image data storage method which, while being prepared to read out image data rapidly, also compress and store the image data.

### SUMMARY OF THE INVENTION

The image data storage device according to the present invention stores image data which has been inputted. And-this image data storage device includes an image data input unit, an image data recording unit, a compression processing unit, a region decision unit, and a compression control unit. The image data input unit receives input of image data. The image data recording unit records image data inputted by the image input unit. The compression processing unit compresses image data to be recorded in the image data recording unit. The region decision unit decides whether or not image data which has been inputted by the image input unit is image data related to an edge portion region of an image. And the compression control unit controls the compression processing unit so that compression processing is canceled for image data which has been decided, by the region decision unit, to be image data related to an edge portion region of an image.

In the image data which is recorded in the image data recording unit, the image data which relates to edge portion regions of the image is recorded in a non-compressed state. The reason is that normally, when outputting the image data, it is read out from image data which relates to an edge portion region of the image.

By storing the image data at the position where reading out is started in a non-compressed state, it becomes unnecessary to decompress this image data before reading it out. Accordingly, there is no delay in starting to read out the image data. On the other hand, since the major portion of the image data is compressed, accordingly the capacity required by the image data which is to be stored by this image data storage device is kept small.

### BRIEF DESCRIPTION OF THE DRAWINGS

FIG. 1 is a block diagram showing the general structure of a photocopier according to a first embodiment of the present invention;

FIG. 2 is a block diagram showing the general structure of an image data storage unit;

FIG. 3 is a block diagram showing the general structure of an image data recording unit;

FIGS. 4A and 4B are figures showing an example of arrangement of compressed regions and non-compressed regions in image data;

FIG. 5 is a flow chart showing the sequence of processing performed by a CPU during storage of image data;

FIG. 6 is a flow chart showing the sequence of processing performed by the CPU in a compression processing step;

FIG. 7 is a figure showing an example of a position for starting readout of the image data;

FIG. 8 is a figure schematically showing a sequence for reading out the image data;

FIG. 9 is a flow chart showing the sequence of processing performed by a first processor during an image forming step;

FIG. 10 is a flow chart showing the sequence of processing performed by a second processor during this image forming step;

FIGS. 11A and 11B are figures showing examples of arrangement of compressed regions and non-compressed regions in the image data, in second and third embodiments of the present invention;

FIG. 12 is a figure showing an alternative example of arrangement of compressed regions and non-compressed regions in the image data;

FIG. 13 is a figure showing the general structure of an image forming system according to an embodiment of the present invention;

FIG. 14 is a block diagram showing the general structure of a photocopier according to another embodiment of the present invention; and

FIG. 15 is a figure showing the structure of an image data recording unit according to another embodiment of the present invention.

### DETAILED DESCRIPTION OF THE INVENTION

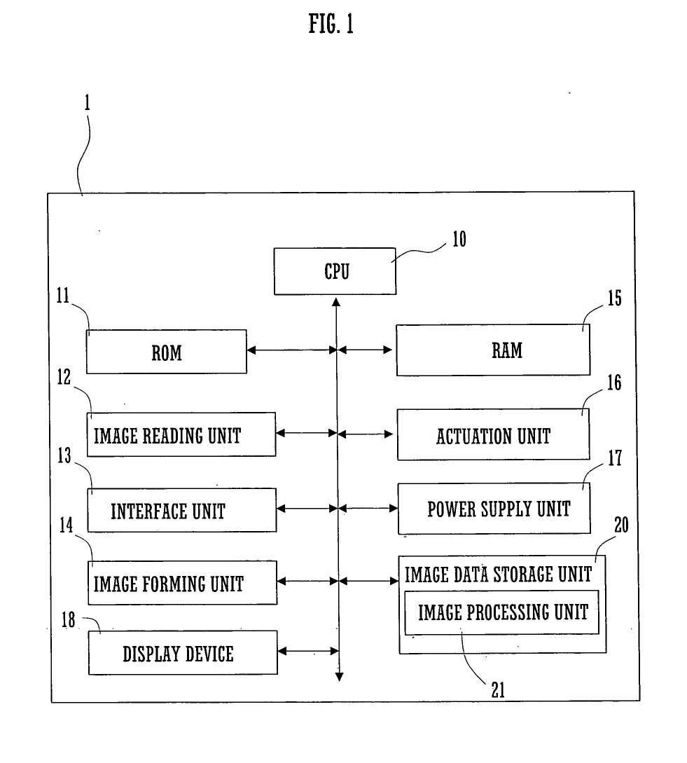

A photocopier, which incorporates an image data storage device according to the present invention, will now be explained using FIG. 1. This photocopier 1 has a ROM 11, a RAM 15, an image reading unit 12, an actuation unit 16, an interface unit 13, an image forming unit 14, a power supply unit 17, a display device 18, and an image data storage unit 20.

A plurality of programs which are required for the operation of the photocopier 1 are recorded in the ROM 11. The RAM 15 is a volatile memory for storing temporary data. By reading an image of a original which has been set in a reading position, the image reading unit 12 generates image data according to the image of the original. The interface unit 13 is endowed with the function of receiving image data which is transmitted from a personal computer. Based upon image data generated by the image reading unit 12 or upon image data received from the interface unit 13, the image forming unit 14 performs image forming processing upon paper by a electronic photographic method. The actuation unit 16 receives input of job commands by the user, or input for setting details of the image forming processing. The power supply unit 17 supplies electrical power of set amounts to the various portions of the photocopier 1. And, according to a request from the user, the display device 18 displays a preview image according to image data stored in the image data storage unit 20. In this embodiment, the image forming unit 14 and the display device 18 each corresponds to the “image data output unit” of the Claims.

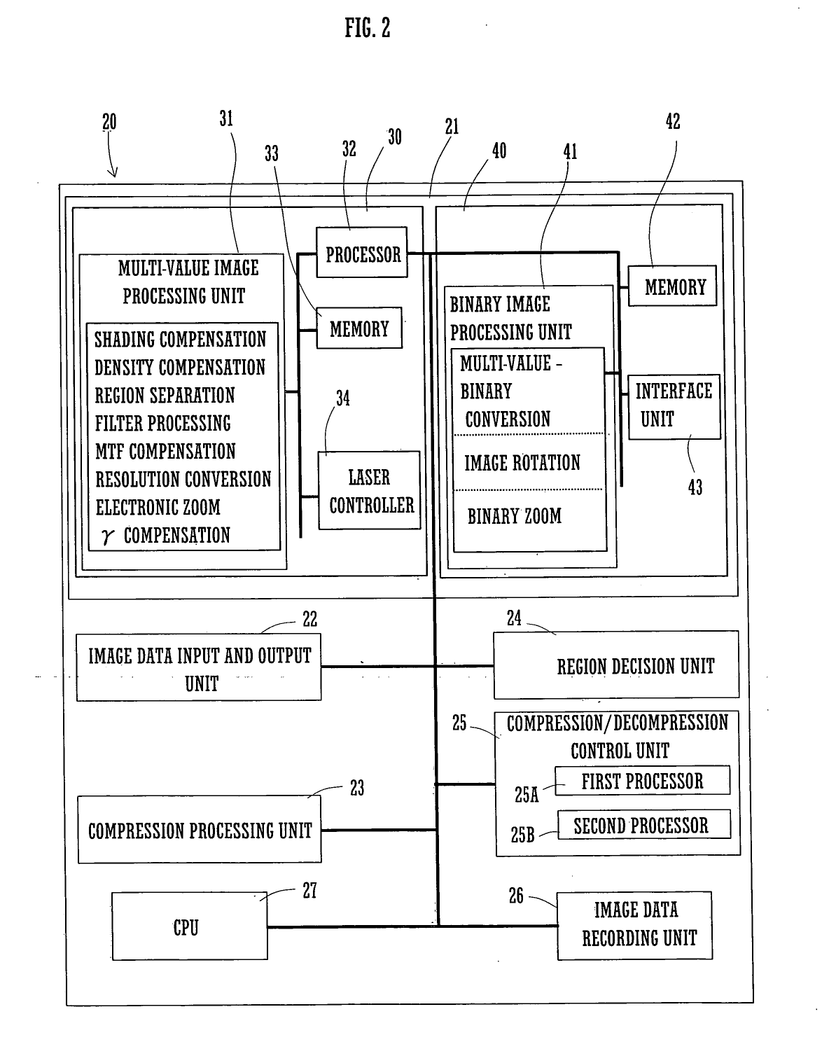

As shown in FIG. 2, the image data storage unit 20 includes an image processing unit 21, an image data input and output unit 22, a region decision unit 24, a compression processing unit 23, a compression/decompression control unit 25, an image data recording unit 26, and a CPU 27.

The image processing unit 21 performs image processing upon the image data which has been inputted via the image data input and output unit 22. This image processing unit 21 includes a main image processing board 30 and an auxiliary image processing board 40. The main image processing board 30 includes a multi-value image processing unit 31, a memory 33, a laser controller 34, and a processor 32. The multi-value image processing unit 31 performs processing upon image data which has arrived such as shading compensation, density compensation, region separation, filter processing, MTF compensation, resolution conversion, electronic zooming (processing for change of scale), gamma compensation, and the like. The memory 33 records image data which has been image processed and control information related to the order of image processing. The laser controller 34 transfers image data upon which image processing has been performed to the image forming unit 14. And the processor 32 controls the various portions of this image processing unit in an integrated manner.

The auxiliary image processing board 40 is connected to the main image processing board 30 via a connector. This auxiliary image processing board 40 includes a binary image processing unit 41, a memory 42, and an interface unit 43. The binary image processing unit 41 performs binary image processing based upon signals from the processor 32 upon the main image processing board 30. The memory 42 records binary image data which has been subjected to image processing, and various types of control information related to the image processing. And the interface unit 43 includes a gate array which controls the memories 33 and 42, a gate array which controls a hard disk, a SCSI which is an external interface, and a gate array which controls the SCSI.

The image data input and output unit 22 receives image data which has been generated by the image reading unit 12, or image data which has been inputted from an external personal computer via the interface unit 13. In this embodiment, the image data input and output unit corresponds to the “image data input unit” of the Claims.

The region decision unit 24 decides, for image data which is sent to the compression processing unit 23 from the image processing unit 21, to which region this image data relates. In particular, the region decision unit 24 decides, for image data which is sent to the compression processing unit 23 from the image processing unit 21, whether it is image data related to an edge portion region of the image, or image data related to a region of the image other than an edge portion. The compression processing unit 23 compresses image data which has been processed by the image processing unit 21. At this time, the compression processing by the compression processing unit 23 is executed based upon a control signal from the compression/decompression control unit 25.

The compression/decompression control unit 25 outputs a control signal to the compression procession unit 23 so that compression processing is not performed upon image data for which it has been decided, by the region decision unit 24, that it is image data related to an edge portion region of the image. In this embodiment of the present invention, the control unit 25 corresponds to the “compression control unit” of the Claims.

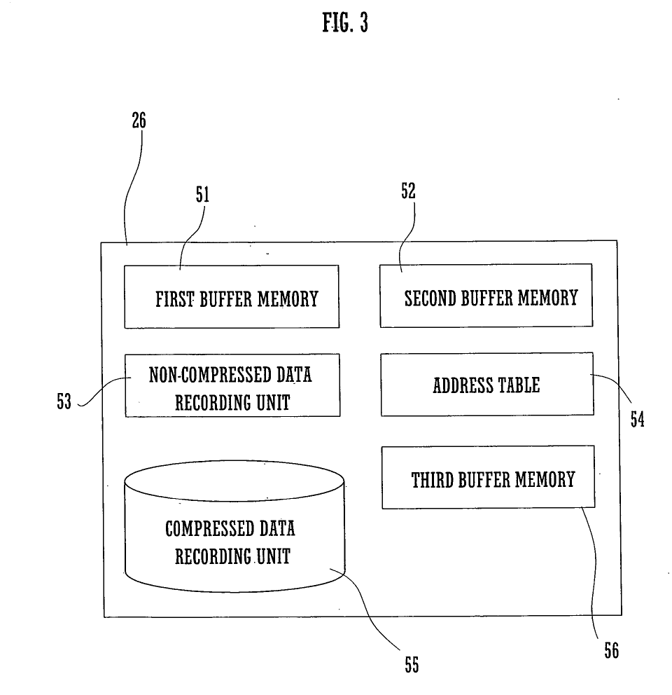

As shown in FIG. 3, the image data recording unit 26 includes a first buffer memory 51, a second buffer memory 52, a third buffer memory 56, an address table 54, a non-compressed data recording unit 53, and a compressed data recording unit 55.

The first buffer memory 51 and the second buffer memory 52 temporarily store image data which is outputted via the image data input and output unit 22. The third buffer memory 56 temporarily records image data which is to be compressed by the compression processing unit 23. The relationship between the image data and the recording region in which that image data is recorded in the third buffer memory 56.

The non-compressed data recording unit 53 is a non-volatile memory which records that image data, among the image data which has been received by the image data input and output unit 22, which has not been compressed by the compression processing unit 23. And the compressed data recording unit 55 is a hard disk which records that image data, among the image data which has been received by the image data input and output unit 22, which has been compressed by the compression unit 23. In this embodiment, the image data in the non-compressed state is recorded in a high speed memory (for example, S-RAM), which can read and write this non-compressed data at higher speed, than the compressed data recording unit 55 can read and write the image data which is in the compressed state.

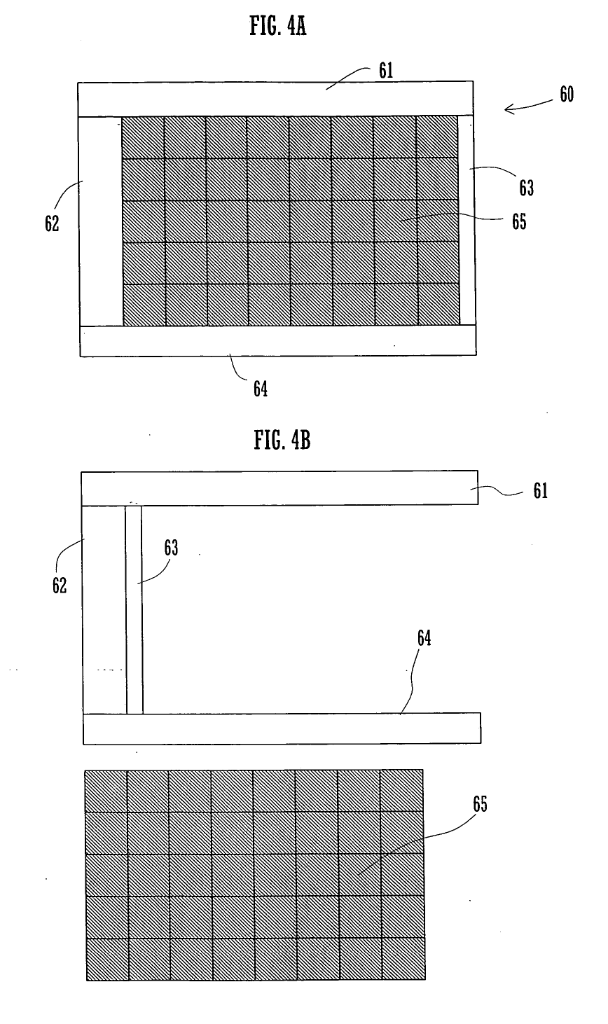

Now, the arrangement of image data which is recorded in the compressed state and of image data which is recorded in the non-compressed state will be explained with reference to FIG. 4A. In FIG. 4A, the image data 60 is image data related to an image of a original of A4 size. In this image data 60, a block of non-compressed image data 61 is allocated to the upper side edge portion of the original image, a block of non-compressed image data 62 is allocated to the left side edge portion of the original image, a block of non-compressed image data 64 is allocated to the lower side edge portion of the original image, and a block of non-compressed image data 63 is allocated to the right side edge portion of the original image. These blocks 61 through 64 of non-compressed image data are allocated so as to surround the compressed image data 65. This compressed image data 65 consists of a plurality of square blocks of image data. In this embodiment, the compressed image data 65 consists of 40 square blocks of image data, arranged in an array 8 horizontally by 5 vertically.

As shown in FIG. 4B, the non-compressed image data blocks 61 through 64 and the compressed image data 65 are separated when recording the image data 60 in the image data recording unit 26, and are each stored in separate places. The non-compressed image data blocks 61 through 64 are not subjected to compression processing, but are simply recorded in the non-compressed data recording unit 53. On the other hand, the compressed image data 65 is recorded in the compressed data recording unit 55, after each of its square blocks of image data has been subjected to compression processing. The addresses of the non-compressed image data blocks 61 through 64 and of each of the square blocks of image data in the compressed image data 65 are recorded in the address table 54.

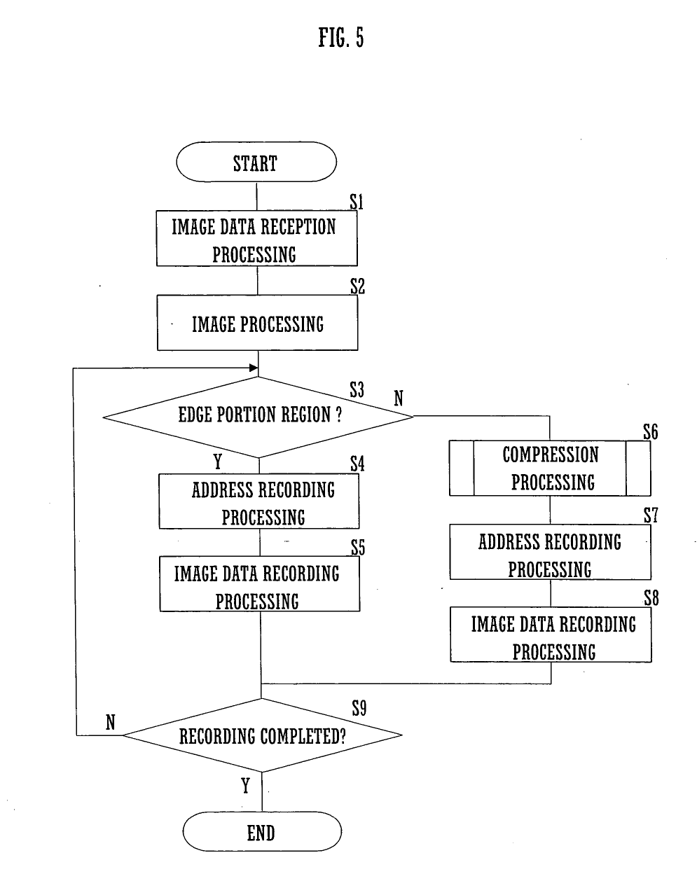

The CPU 27 controls the operation of the various sections of this image data storage unit 20 in an integrated manner. FIG. 5 is a flow chart showing the sequence of processing performed by the CPU 27 during storage of image data. First, the CPU 27 receives image data via the image data input and output unit 22 (S1). Next, image processing is performed by the image processing unit 21 upon the image data which has been received by the CPU 27 (S2). The image data upon which image processing has been performed in the step S2 is sent to the compression processing unit 23.

Next, the CPU 27 performs region decision processing upon the image data which is sent to the compression processing unit 23 from the image processing unit 21 (S3). This region decision processing in the step S3 is processing for deciding whether or not the image data which is the subject of region decision is image data related to an edge portion region of the image. Here, the CPU 27 decides whether or not the image data which is the subject of region decision is image data related to any one of the blocks of non-compressed image data 61 through 64.

In this region decision processing of the step S3, if the image data which is the subject of region decision is image data related to an edge portion region of the image, then the CPU 27 calculates the address of the region in which this image data is recorded and records it in the address table 54 (S4). And next, the CPU 27 records, in the storage region of the non-compressed data recording unit 53 which is specified by the address which has been recorded in the address table 54, image data corresponding to that address (S5).

On the other hand if, in the region decision processing of the step S3, the image data which is the subject of region decision is not image data related to an edge portion region of the image, then the CPU 27 performs compression processing upon that image data (S6).

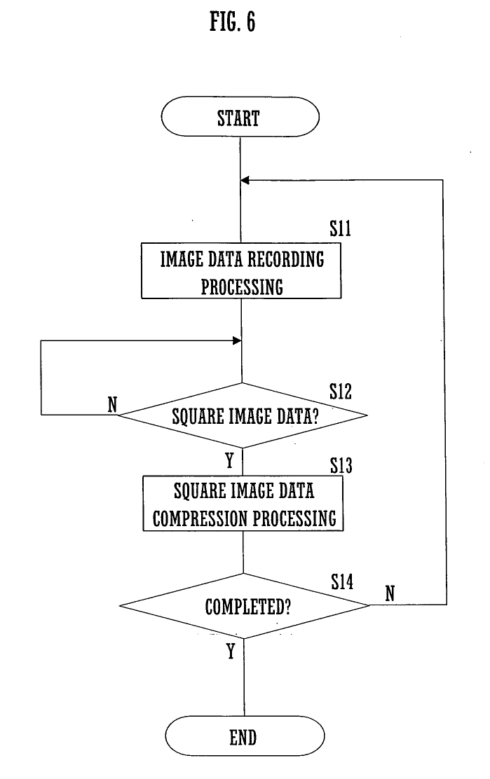

FIG. 6 is a flow chart showing the-sequence of processing performed by the CPU in the compression processing step of S6. When the compression processing step of S6 starts, the CPU 27 records the image data which is to be compressed in the third buffer memory 56 (S11). Next, the CPU 27 waits until one square block of image data is recorded in the third buffer memory 56 (S12).

In the wait step S12, when one square block of image data has been recorded in the third buffer memory 56, the CPU 27 performs compression processing in the compression processing unit 23 upon this square block of image data which has been recorded (S13).

Next, the CPU 27 decides whether or not the compression processing has been completed for all of the square blocks of image data (S14), and if some square blocks of image data still remain to be processed, then the flow of control is transferred back to the step S11 again. On the other hand, if compression processing has now been completed for all of the square blocks of image data, then the CPU 27 terminates this compression processing step S6.

Next, the CPU 27 records the address of the region in which each square block of image data is to be recorded in the address table 54 (S7). And next, the CPU 27 records, in the storage region of the compressed data recording unit 55 which is specified by the address recorded in the address table 54, the image data which corresponds to that address (S8).

Next, the CPU 27 decides whether or not all of the image data which is to be recorded has been recorded in the image data recording unit 26 (S9), and, if some image data still is present that must be recorded, then the flow of control is transferred back to the step S3 again for further region decision processing.

By the steps S1 through S9 and S11 through S14 described above, image data related to the image of one original page is stored in the image data storage unit 26 in a compressed state. It should be understood that, although portions which are stored in a non-compressed state are included in the image data stored in the image data storage unit 26, these portions which are stored in a non-compressed state amount to 5% to 15% of the total amount of image data. Due to this, even though there are some blocks of image data which are stored in a non-compressed state, the capacity for storing image data in the image data storage unit 26 is made sufficiently compact.

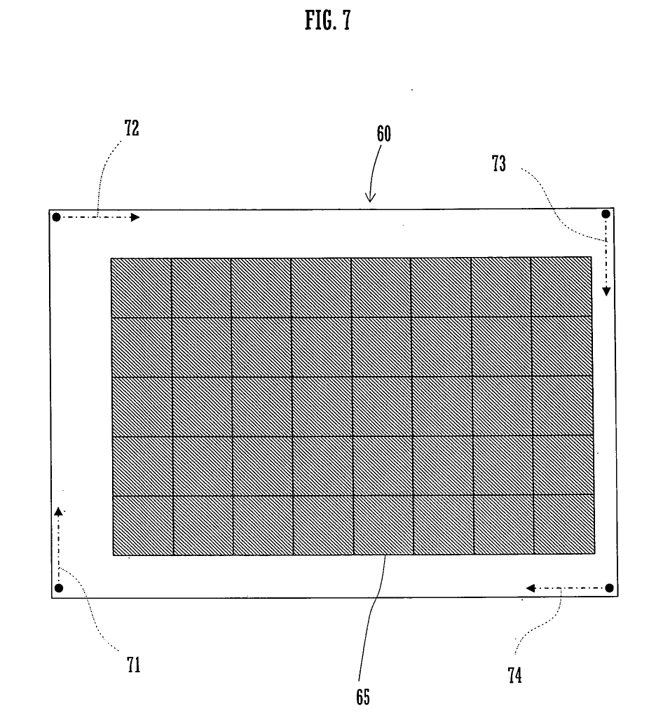

Next, the processing for reading out image data stored in the image data storage unit 26 will be explained. When reading out image data, the read out starting position is different according to the rotation processing which is applied to this image data. FIG. 7 shows an example of a position for starting readout of image data. The arrow sign 71 relates to the case of rotation processing through 0°; in other words, it shows the starting position and the read out direction when no rotation processing is to be performed. The arrow sign 72 shows the starting position and the read out direction when rotation processing through 90° is to be performed. The arrow sign 73 shows the starting position and the read out direction when rotation processing through 180° is to be performed. And the arrow sign 74 shows the starting position and the read out direction when rotation processing through 270° is to be performed.

In this embodiment, when starting to read out from any one of the above described four read out starting positions, image data which has been stored in a non-compressed state is initially read out. Due to this, it is possible to start reading out the image data before performing decompression processing upon that portion of the image data which has been compressed.

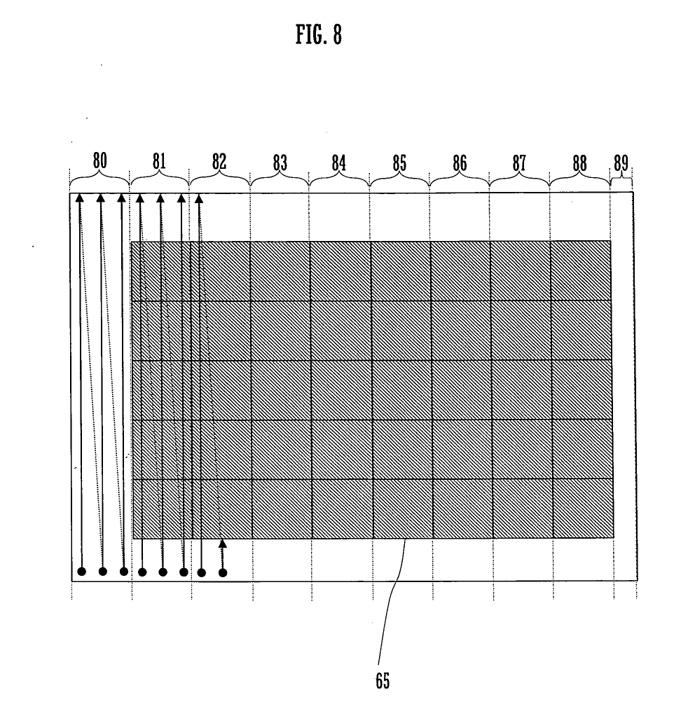

The processing for reading out the image data will now be explained using FIG. 8. Here, there is shown an example in which, according to an image forming command from the user, reading out is started as shown by the arrow sign 71 in FIG. 7. The image data is sent from the non-compressed data recording unit 53 and the compressed data recording unit 55 to the first buffer memory 51 or the second buffer memory 52, and is temporarily stored in the first buffer memory 51 or the second buffer memory 52. And the image data is supplied to the image forming unit 14 from the first buffer memory 51 and the second buffer memory 52.

When storing the image data in the first buffer memory 51 or the second buffer memory 52, the image data is separated into a plurality of band-shaped processing blocks 80 through 89, and storage of the image data is performed for each of these processing blocks 80 through 89. Initially, the image data in the non-compressed state related to the processing block 80 is stored in the first buffer memory 51. Since this image data related to the processing block 80 is recorded in high speed memory, the storage processing for this processing block 80 is performed rapidly. At the same time, with regard to the image data related to the processing block 81, decompression processing of the compressed image data is performed, and, after this decompression processing has been completed, the image data relating to this processing block 81 is stored in the second buffer memory 52. The decompression processing and storage processing for the image data related to the processing blocks 82 through 89 is started sequentially at the time points that space can become available in the first buffer memory 51 or the second buffer memory 52.

The image data for each of the processing blocks 80 through 89 which has been stored in the first buffer memory 51 or the second buffer memory 52 is supplied to the image forming unit 14 for each processing block 80 through 89 at a time. And the image forming unit 14 is able to start image forming processing at the time point that the image data related to the first processing block 80 has been supplied. Due to this, the image forming processing is started rapidly after the user issues an image forming command.

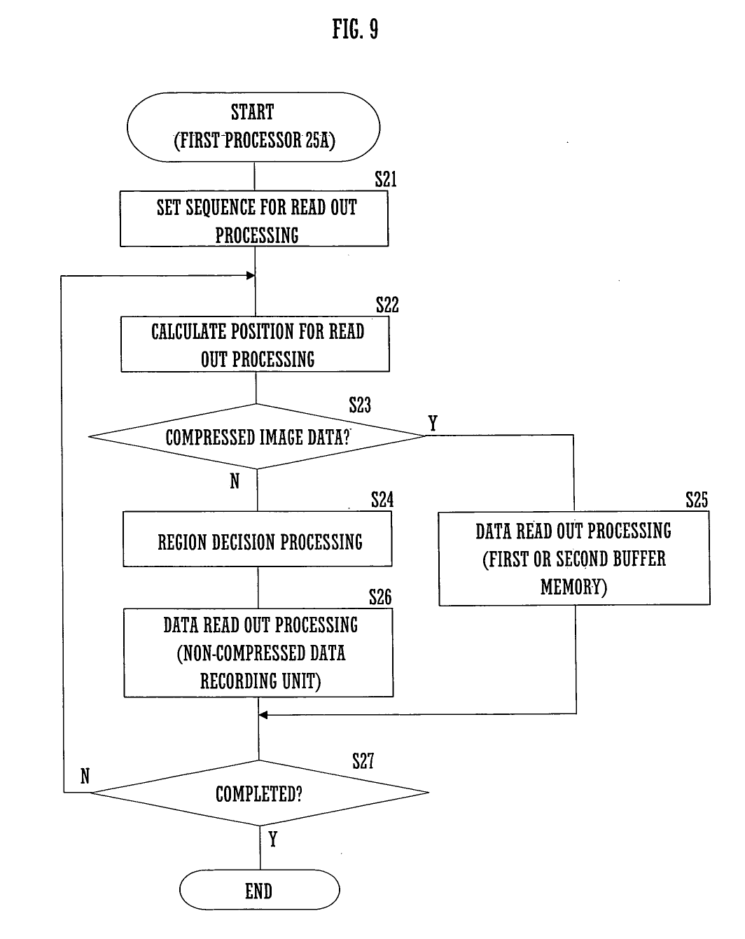

FIG. 9 is a flow chart showing the sequence of processing performed by the first processor 25A during this image forming processing. The first processor 25A performs the task of controlling the processing for reading out the image data and outputting it to the image data input and output unit 22. During image forming processing, setting information is supplied from the CPU 27 to the first processor 25A and the second processor 25B, including information related to the amount of image data, corresponding to the size of paper upon which printing is to be performed. The first processor 25A first sets the sequence for the read out processing of the image data (S21). In this setting step S21, the first processor 25A sets the starting address and the reading out sequence for the image data, according to the setting for angle of rotation included in the image forming command from the user.

Next, the first processor 25A calculates the position of the image data for read out processing (S22). After this calculation step S22, the first processor 25A decides whether the position of the image data for read out processing corresponds to one of the non-compressed image data blocks 61 through 64, or to the compressed image data 65 (S23).

If, in the decision step S23, it is decided that the image data for read out processing belongs to the blocks of non-compressed image data 61 through 64, then the first processor 25A performs region decision processing upon the image data for read out processing (S24). In concrete terms, in this case, the first processor 25A decides to which of the blocks the image data for read out processing belongs to: the block of non-compressed image data 61, the block of non-compressed image data 62, the block of non-compressed image data 63, or the block of non-compressed image data 64. Next, the first processor 25A refers to the address table 54, and reads out the image data by the non-compressed data recording unit 53 (S26).

If, on the other hand, in the decision step S23, it is decided that the image data for read out processing belongs to the compressed image data 65, then the first processor 25A refers to the address table 54, and reads out the image data, after it has been decompressed, from the first buffer memory 51 or the second buffer memory 52 (S25).

It should be understood that the image data which has been read out in the image data reading out step of S26 or S25 is sent to the image forming unit 14 via the image data input and output unit 22. After the image data read out step of S26 or S25, the first processor 25A decides whether or not the reading out of image data has been completed (S27); and, if it has not been completed, then the flow of control is transferred back to the calculation step S22 again.

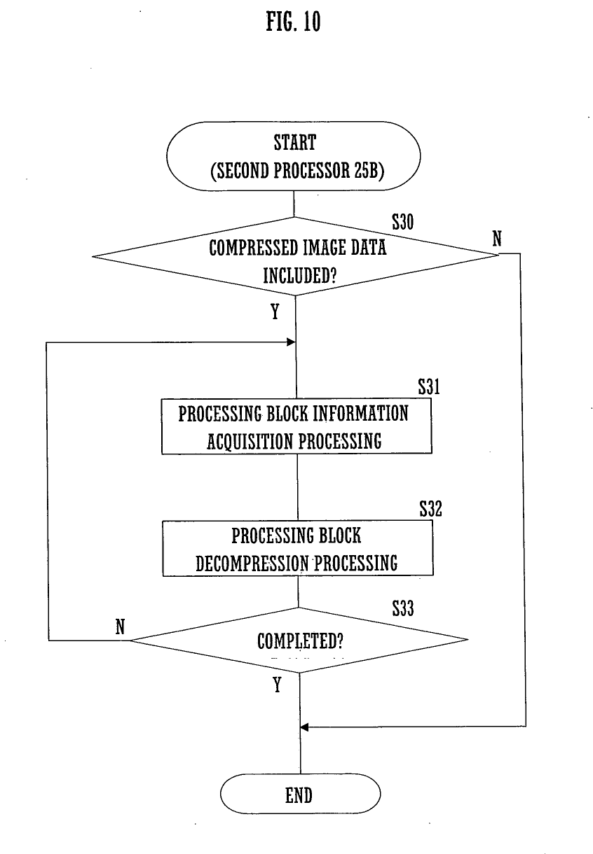

FIG. 10 is a flow chart showing the sequence of processing performed by the second processor 25B during image forming processing. This second processor 25B performs the task of controlling the decompression processing of the image data belonging to the processing block which is read out next by the first processor 25A.

First, the second processor 25B decides whether or not any compressed data is included in the image data belonging to the processing block which is read out next by the first processor 25A (S30). If, in this decision step S30, it is decided that compressed image data is indeed included in the image data belonging to the processing block which is read out next by the first processor 25A, then the second processor 25B acquires information for the processing block upon which decompression processing must be performed (S31). In this step S31, the second processor 25B specifies the square blocks of image data included in the processing block upon which decompression processing must be performed, based upon the rotational angle setting for the image.

Next, the second processor 25B performs decompression processing upon the plurality of square blocks of image data which are included in the relevant processing block (S32). And the second processor 25B stores the square image data, after it has been decompressed, in the first buffer memory 51 or the second buffer memory 52. It should be understood that, if both the first buffer memory 51 or the second buffer memory 52 are in the full state, then the second processor 25B waits until spare room becomes available in either the first buffer memory 51 or the second buffer memory 52.

Thereafter, the second processor 25B waits until the decompression processing of the image data for the relevant processing block has been completed (S33), and, when it is completed, the second processor 25B terminates the decompression processing of the image data belonging to the relevant processing block.

In this first embodiment of the present invention, by the two processors 25A and 25B which have received the image forming information from the CPU 27 performing processing in parallel, the reading out processing of the image data and the decompression processing of the image data are performed at the same time. Due to this, after an image forming command has been issued, along with the reading out of the image data being started immediately, also the decompression processing for the image data to be read out next is performed. Because of this, it is possible to supply the compressed image data rapidly to the image forming unit 14. Furthermore, even if the image forming processing is accompanied by rotation processing, it is unlikely that any delay will occur in the starting of image forming processing for the compressed image data.

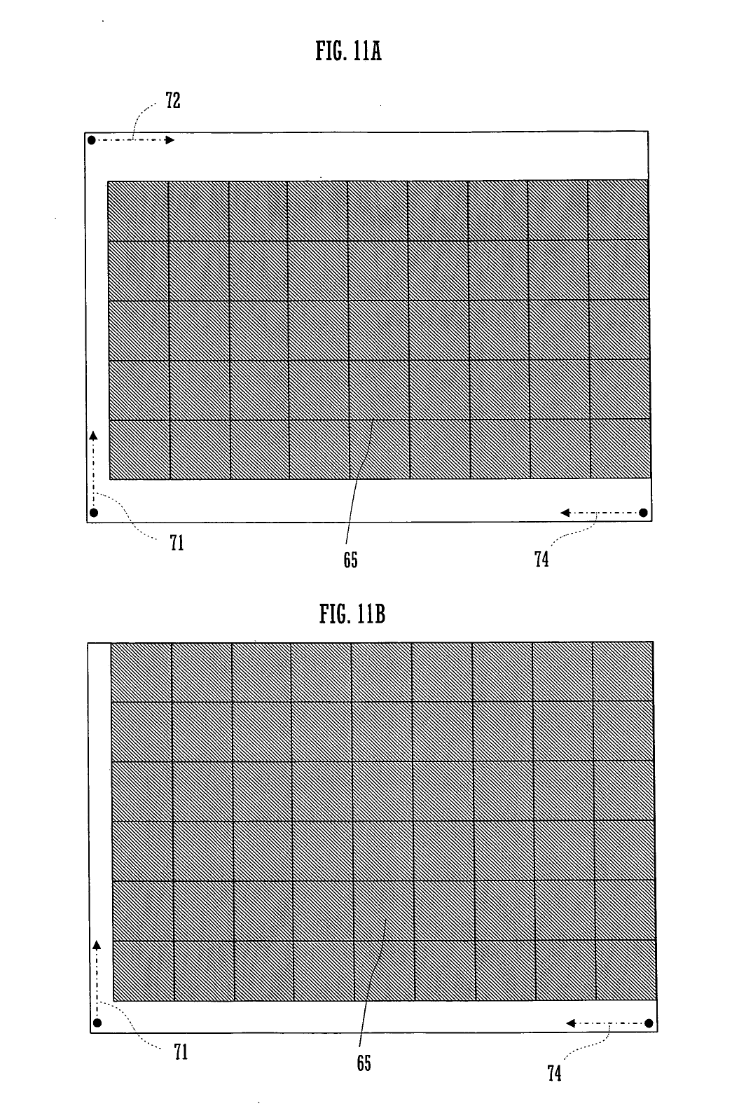

FIG. 11A shows the arrangement of non-compressed image data and compressed image data in the image data, according to a second embodiment of the present invention. This second embodiment differs from the first embodiment described above, in that the image data related to the right side edge portion region is compressed. Due to this, one further column of square blocks of image data is appended, so that the proportion of compressed regions in the image data can be increased, as compared with the first embodiment described above.

And FIG. 11B shows the arrangement of non-compressed image data and compressed image data in the image data, according to a third embodiment of the present invention. This third embodiment differs from the first embodiment described above, in that the image data related to the upper side edge portion region and also the right side edge portion region is compressed. Since, due to this, both the number of rows and the number of columns of square blocks of image data are increased, accordingly the proportion of compressed regions in the image data can be further increased, as compared with the first and second embodiments described above.

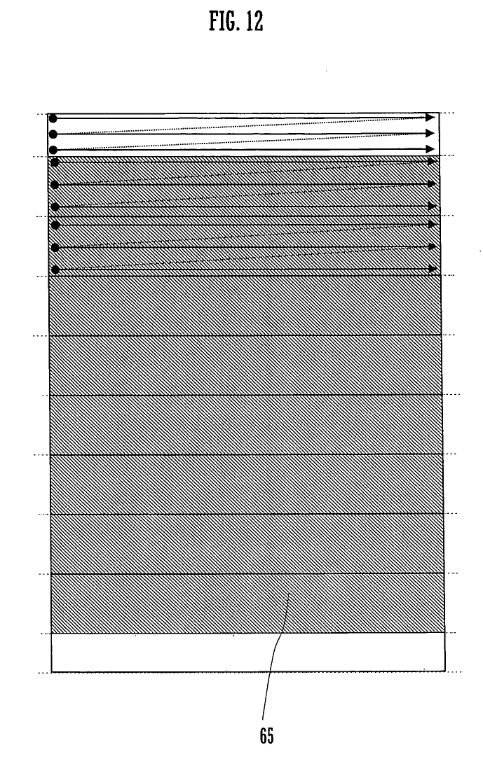

It should be understood that although, in the first through third embodiments described above, the compressed image data 65 consisted of a plurality of square blocks of image data, it would also be acceptable, as shown in FIG. 12, for the compressed image data 65 to consist of a plurality of band shaped rectangular blocks of image data.

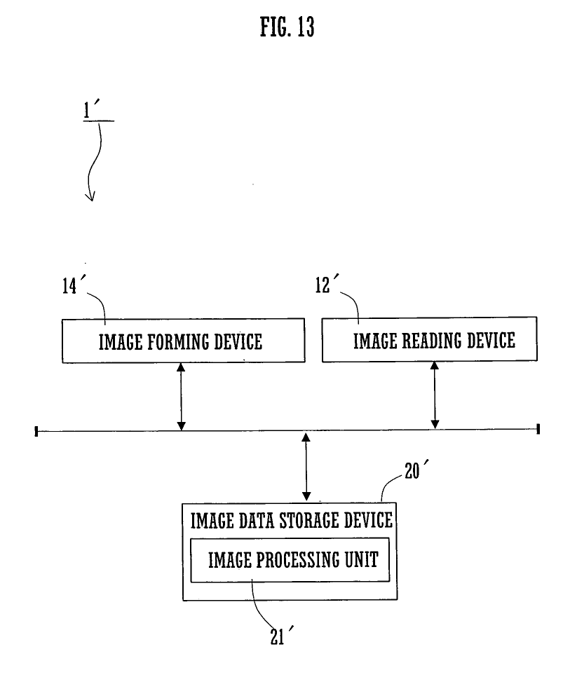

Furthermore although, in the first through the third embodiment described above, a structure was shown in which the image reading unit 12, the image forming unit 14, and the image data storage unit 20 were provided within a single unitary device, it would also be acceptable for the image reading unit 12, the image forming unit 14, and the image data storage unit 20 to be separate devices. For example, as shown in FIG. 13, an image forming system 1′ might be constructed by connecting together an image reading unit 12′, an image forming unit 14′, and an image data storage unit 20′.

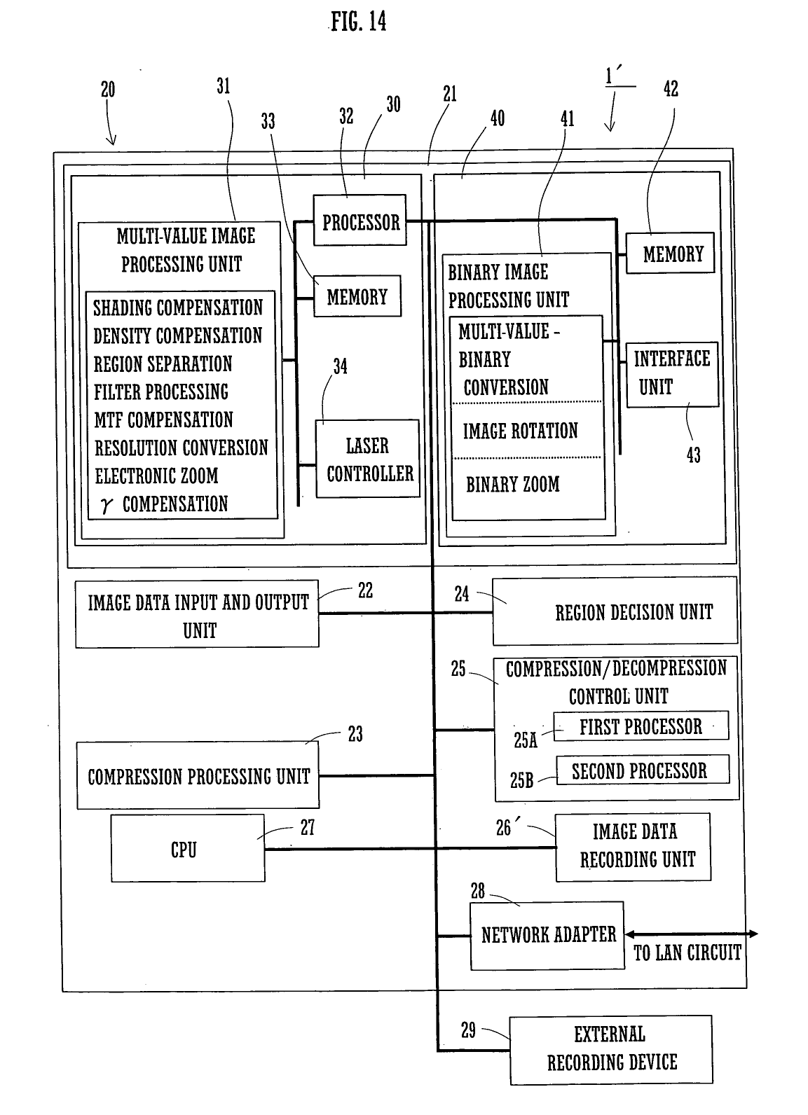

FIG. 14 is a block diagram showing the general structure of a photocopier 1′ according to a fourth embodiment of the present invention. The overall structure of this photocopier 1′ is the same as that of the photocopier 1, described above. However, in addition to the structure of the photocopier 1, this photocopier 1′ further includes a network adapter 28 and an external recording device 29. The network adapter 28 is connected to a network such as a LAN circuit or the like. This network adapter 28 controls communication between the photocopier 1′ and external devices which is performed via the network. A removable disk is fitted to the external recording device 29. In this embodiment this external recording device is an opto-magnetic disk drive, into which an opto-magnetic disk is loaded.

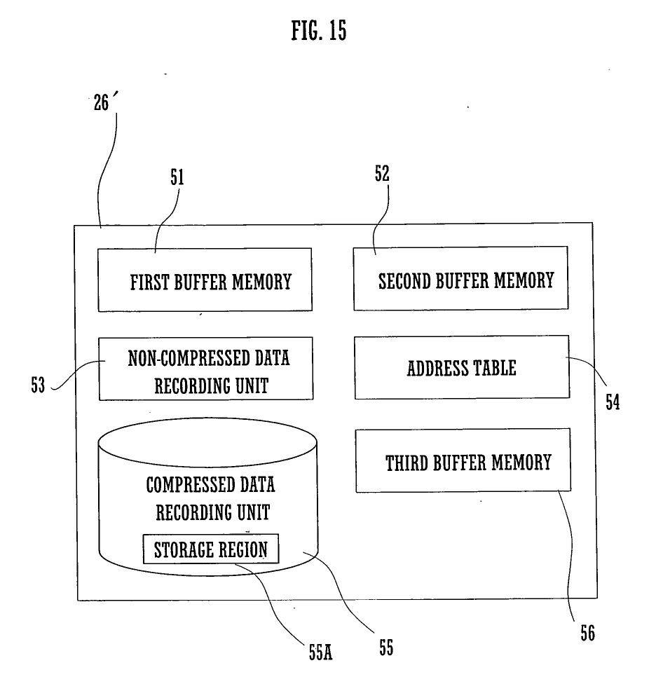

FIG. 15 is a figure showing the structure of an image data recording unit 26′ in the photocopier 1′. The overall structure of this image data recording unit 26′ is the same as that of the image data recording unit 26, described above. However, a storage region 55A for storing the image data blocks 61 through 64 is provided within the compressed data recording unit 55.

In this fourth embodiment, based upon a command from the user, the CPU 27 stores the non-compressed blocks of image data 61 through 64 in the storage region 55A. When storing the non-compressed blocks of image data 61 through 64 in the storage region 55A, these non-compressed blocks of image data 61 through 64 are compressed by the compression/decompression control unit 25 controlling the compression processing unit 23. It should be understood that, in this fourth embodiment, the CPU 27 corresponds to the “storage unit” of the Claims.

By compressing the image data blocks 61 through 64 when storing them in this manner, it becomes easy to perform long term storage or transfer of the image data blocks 61 through 64. In this embodiment, based upon a command from the user, the compressed image data blocks 61 through 64 may be transferred from the storage region 55A to the external recording device 29, so as to be written upon the opto-magnetic disk which is loaded into the external recording device 29. Furthermore, based upon a command from the user, the compressed image data blocks 61 through 64 may be transferred from the storage region 55A to the network adapter 28. Thereafter, these compressed image data blocks 61 through 64 are transferred to an external device which is connected via the network.

With this photocopier 1′, file names such as “****A” are allocated to the image data blocks 61 through 64, while file names such as “****B” are allocated to the compressed image data 65. In this manner, identifiers are appended to the tail ends of the file names in the photocopier 1′, for identifying whether the files are the image data blocks 61 through 64 or the compressed image data 65.

As a result, if image data in the compressed state has been received from externally by the photocopier 1′, it is possible to determine whether or not it is necessary to decompress this image data in advance. If, for example, a file with a file name of “****A” has been received from externally by the photocopier 1′, then, before image forming processing is performed, decompression processing upon this file which has been received is completed, and it is stored in the non-compressed data recording unit 53. Due to this, in this fourth embodiment as well, just as with the first through the third embodiments described above, no delay due to performing decompression processing upon the blocks of image data 61 through 64 occurs when starting the image forming process.

Finally, in the above described explanation of an embodiment of the present invention, all of the features are shown by way of example, and should not be considered as being limitative of the present invention. The scope of the present invention is not to be defined by any of the features of the embodiment described above, but only be the scope of the appended Claims. Moreover, equivalents to elements in the Claims, and variations within their legitimate and proper scope, are also to be considered as being included within the scope of the present invention.

What is claimed is:

1. An image data storage device which stores inputted image data, comprising:
an image data input unit which receives input of image data;
an image data recording unit which records image data inputted by the image input unit;
a compression processing unit which compresses image data to be recorded in the image data recording unit;
a region decision unit which decides whether or not image data which has been inputted by the image input unit is image data related to an edge portion region of an image; and
a compression control unit which controls the compression processing unit in such a manner that compression processing is canceled for image data which has been decided, by the region decision unit, to be image data related to an edge portion region of an image.

2. An image data storage device as described in claim 1, further comprising an image data output unit which performs output processing based upon image data which has been recorded in the image data recording unit; and
wherein the compression control unit controls the compression processing unit in such a manner that compression processing is only cancelled for image data related to a read out starting region which is an edge portion region, among image data related to edge portion regions of the image, for which the data is to be initially supplied to the image data output unit.

3. An image data storage device as described in claim 2,
wherein, in parallel with supplying and processing the image data related to the read out starting region to the image data output unit, decompression processing is performed for the image data next to be supplied to the image data output unit.

4. An image data storage device as described in claim 3,
wherein the image data is bitmap format image data, and image data related to regions other than edge portion regions of the image consists of a plurality of square blocks of image data arranged in matrix form.

5. An image data storage device as described in claim 4, further comprising
a first recording unit in which image data in the compressed state is recorded, and
a second recording unit in which image data in the non-compressed state is recorded; and
wherein the data transfer speed of the first recording unit is faster than that of the second recording unit.

6. An image data storage device as described in claim 5, further comprising a storage unit which stores the image data in the non-compressed state which has been recorded in the second recording unit in a predetermined recording region; and
wherein the compression control unit causes the image data stored in the predetermined recording region to be compressed by the compression processing unit.

7. A photocopier, comprising:
an image data storage device as described in claim 1;
an image reading unit which, along with reading an image of an original, outputs image data related to the original which it has read to the image data storage device; and
an image forming unit which performs image forming processing, based upon image data which has been supplied from the image data storage device.

8. A image forming system, comprising:
an image data storage device as described in claim 1;
an image reading device which, along with reading an image of an original, outputs image data related to the original which it has read to the image data storage device; and
an image forming device which performs image forming processing, based upon image data which has been supplied from the image data storage device.

9. An image data storage method in which inputted image data is stored after having been subjected to compression processing, comprising:
a step in which an image data input unit receives image data;
a step in which a region decision unit decides whether or not image data which has been inputted by the image input unit is image data related to an edge portion region of an image;
a step in which a compression control unit controls a compression processing unit so that compression processing is canceled for image data which has been decided, by the region decision unit, to be image data related to an edge portion region of an image;
a step in which the compression processing-unit compresses image data which has been received by the image data input unit, based upon control by the compression control unit; and
a step in which an image data recording unit records image data inputted by the image input unit.
